(19) United States
(12) Patent Application Publication
(10) Pub. No.: US 2026/0296386 A1
(43) Pub. Date: Oct. 1, 2026

(54) AUTONOMOUS BRAKING SYSTEM AND METHOD FOR OFFROAD VEHICLES

(71) Applicant: Robert Bosch GmbH, Stuttgart (DE)

(72) Inventor: Kurt Person, Florence, WI (US)

(21) Appl. No.: 19/095,776

(22) Filed: Mar. 31, 2025

(51) Int. Cl. B60T 7/12; B60T 8/58; B62M 27/02

(52) U.S. Cl. CPC B60T 7/12; B60T 8/58; B60T 2250/00; B60T 2250/04; B62M 27/02

(57) ABSTRACT

A system and method of active brake control of an offroad vehicle, such as a snowmobile, having a tether port in electrical connection with a riding tether to indicate an occupancy of a rider for the vehicle. When the riding tether becomes disconnected from the tether port, a brake is applied until the measured velocity of the propulsion system—such as a tread—is measured to be at or below a threshold value and a validation cycle operation is completed to formally disengage and reengage a prime mover of the vehicle.

### TECHNICAL FIELD

This disclosure relates to control systems for offroad vehicles. In particular, this disclosure is directed to braking systems for offroad vehicles.

### BACKGROUND

Off-road vehicles comprise safety systems that are distinct from road vehicles such as cars and trucks. In particular, snowmobiles are operated in conditions of snow and ice, and will frequently be used to traverse hills and other inclines. For these reasons, it is possible for a snowmobile to move or slide downhill when a rider is not engaged with piloting the snowmobile.

It is therefore desirable for a snowmobile or other all-terrain vehicle to utilize systems and mechanisms to minimize undesired motion of the vehicle not by the direction of a rider, including on hilly terrain.

### SUMMARY

One aspect of this disclosure is directed to a snowmobile control system comprising a brake controller that engages a brake applied to a tread of the snowmobile, an occupancy sensor that generates a occupancy signal, a status sensor that generates a status signal indicating the operational state of a prime mover of the snowmobile, and a master controller in data communication with the occupancy sensor and the status sensor. The occupancy signal indicates whether a riding tether is electrically connected to a tether port of the snowmobile. The status signal indicates either an active state or an inactive state of a prime mover of the snowmobile. The master controller activates the brake controller in response to receiving an occupancy signal indicating the riding tether is not electrically connected to the tether port and a status signal indicating an active state of the prime mover. The occupancy sensor is in electrical communication with the tether port.

Another aspect of this disclosure is directed to a method of snowmobile control during operation of the snowmobile while a rider tether is in electrical connection to a tether port of the snowmobile. The method comprises steps of detecting that the riding tether is electrically disconnected with the tether port via an occupancy sensor, activating a brake controller to engage a brake of the snowmobile against a tread of the snowmobile in response to the removal of the riding tether, and maintaining the brake engagement until a disengagement condition is detected.

A further aspect of this disclosure is directed to a non-transitory computer-readable medium having instructions thereon that cause a processor to, in response to the instructions, perform a method of snowmobile control during operation of the snowmobile while a rider tether is in electrical connection to a tether port of the snowmobile. The method described by the instructions comprises steps of detecting that the riding tether is electrically disconnected with the tether port via an occupancy sensor, activating a brake controller to engage a brake of the snowmobile against a tread of the snowmobile in response to the removal of the riding tether, and maintaining the brake engagement until a disengagement condition is detected.

The above aspects of this disclosure and other aspects will be explained in greater detail below with reference to the attached drawings.

### BRIEF DESCRIPTION OF THE DRAWINGS

FIG. 1 is an illustration of a snowmobile and rider.

FIG. 2 is a diagrammatic illustration of a snowmobile and rider, including additional system components of the snowmobile.

FIG. 3 is a diagrammatic illustration of a snowmobile and a rider wherein a riding tether is not electrically connected to a tether port of the snowmobile.

FIG. 4 is a chart showing behavior of a snowmobile under changing conditions.

FIG. 5 is a block diagram illustrating a method of autonomous braking of a snowmobile.

FIG. 6 is a block diagram illustrating a method of autonomous braking of a snowmobile.

### DETAILED DESCRIPTION

The illustrated embodiments are disclosed with reference to the drawings. However, it is to be understood that the disclosed embodiments are intended to be merely examples that may be embodied in various and alternative forms. The figures are not necessarily to scale and some features may be exaggerated or minimized to show details of particular components. The specific structural and functional details disclosed are not to be interpreted as limiting, but as a representative basis for teaching one skilled in the art how to practice the disclosed concepts.

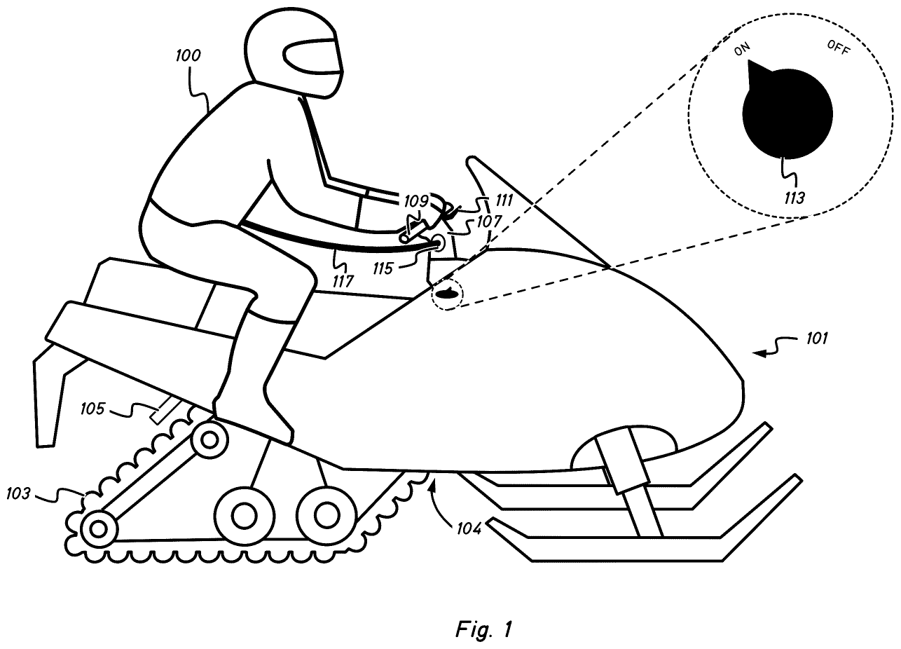

FIG. 1 shows a rider 100 on a snowmobile 101. Snowmobile 101 is propelled by a tread 103 driven by a prime mover 104. Prime mover 104 may comprise an electric motor, an internal combustion motor, a hybrid motor, or some other mover configuration known to one of ordinary skill in the art without deviating from the teachings disclosed herein. Tread 103 can be slowed by brake 105. Rider 100 can control the motion of snowmobile 101 utilizing controls 107, which include a throttle 109 and a brake lever 111. The operational state of prime mover 104 is controlled via an activation control 113. In the depicted embodiment, activation control 113 is a toggle switch having an “ON” and “OFF” setting that correspond to an active state of prime mover 104 and an inactive state of prime mover 104 respectively, but other embodiments may comprise other configurations without deviating from the teachings disclosed herein. In some such embodiments, activation control 113 may comprise a keyed switch, a keyed ignition control, a push button, or any other activation control known to one of ordinary skill without deviating from the teachings disclosed herein.

Snowmobile 101 additionally comprises a tether port 115 to which rider 100 connects a riding tether 117 during operation of the snowmobile 101. Riding tether 117 is attached to rider 100 and forms a connection with tether port 115. In the depicted embodiment, riding tether 117 may comprise a magnetic coupling mechanism to attach to tether port 115, but other embodiments may comprise other configurations without deviating from the teachings disclosed herein.

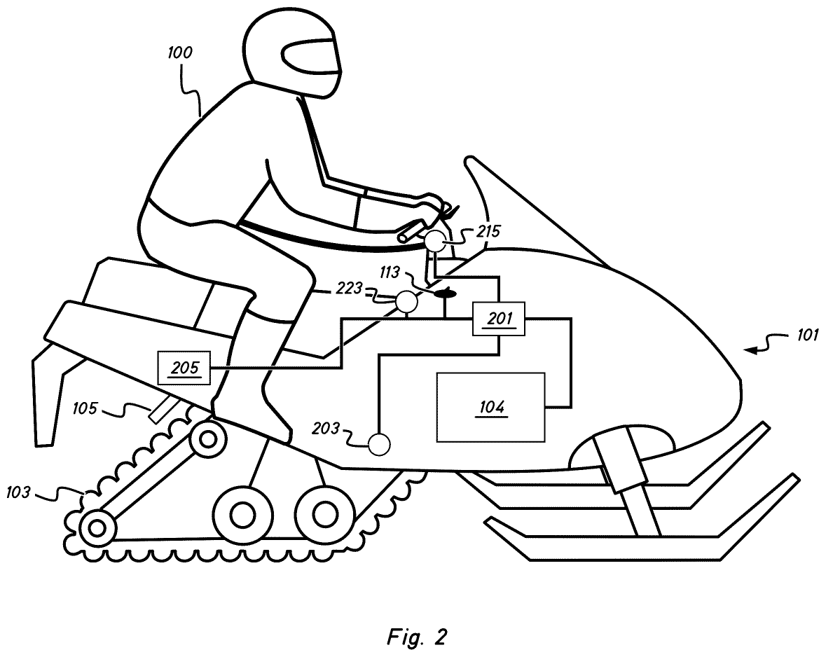

FIG. 2 is a diagrammatic illustration of snowmobile 101 showing addition features of the snowmobile 101 not visible from the exterior. Snowmobile 101 additionally comprises a master controller 201 that is in data communication with other elements of snowmobile 101, including prime mover 104. Snowmobile additionally comprises a tread sensor 203 in data communication with the master controller 201 which generates a velocity signal indicating a rotational speed of the tread. Master controller 201 can utilize the velocity signal for numerous functions, including calculation of the moving speed of the snowmobile 101. Master controller 101 is additionally in data communication with a brake controller 205. Brake controller 205 is suitable to engage brake 105, including in response to commands transmitted by master controller 101. In some embodiments, brake controller 205 may be utilized by an electronic braking system, wherein brake lever 111 (see FIG. 1) additionally engages with brake 105 via brake controller 205, but other embodiments may comprise an analog or hybrid braking system without deviating from the teachings disclosed herein. In the depicted embodiment, brake 105 comprises a variable-force brake actuator and brake controller 205 is a operable to control brake 105 to apply a braking force ranging from zero bar (disengaged brake 105) up to 20 bar at the high end. Other embodiments may comprise a different range of braking forces, or a static braking force without deviating from the teachings disclosed herein. In some embodiments, brake 105 may comprise a fixed-force brake actuator and the braking force is a constant. In some embodiments, brake 105 may comprise a variable-force brake actuator, but brake controller 205 may be configured to utilize a select subset of available ranges, including in some such embodiments a maximum braking force when operating in certain conditions or modes or operation. Other embodiments may comprise other configurations without deviating from the teachings disclosed herein.

In the depicted embodiment, master controller 201 is embodied as a programmable hardware controller with preset functions defined by sub-circuits. Other embodiments may comprise other configurations without deviating from the teachings disclosed herein. In some such embodiments, master controller 201 may be embodied as a specialized processor device, firmware-programmed controller, a microcontroller, a mobile processing device, a smartphone, a tablet computer, a laptop computer, a wearable computing device, a desktop computer, a personal digital assistant (PDA) device, a handheld processor device, a system of processors or sub-processors configured in wired or wireless communication, or any other alternative embodiment known to one of ordinary skill in the art. In some embodiments, master controller 201 is a computing device further comprising a non-transitory medium, and is suitable to read computer-executable data stored upon the non-transitory medium. Computer-executable data may include instructions and other data which cause a general purpose computer, special purpose computer, or special purpose processing device to perform a certain function or group of functions. Computer-executable data may also include program modules that are executed by computers in stand-alone or network environments. Program modules may include routines, programs, objects, components, or data structures that perform particular tasks or implement particular abstract data types. Computer-executable data, associated data structures, and program modules represent examples of the program code means for executing steps of the methods disclosed herein. The particular sequence of such executable instructions or associated data structures represents examples of corresponding acts for implementing the functions described in such steps. A memory storing computer-executable data accessible to some embodiments of master controller 101 may be embodied as a non-transitory computer-readable storage medium or a machine-readable medium for carrying or having computer-executable instructions or data structures stored thereon. Such non-transitory computer-readable storage media or machine-readable medium may be any available media embodied in a hardware or physical form that can be accessed by a general purpose or special purpose computer. By way of example, and not limitation, such non-transitory computer-readable storage media or machine-readable medium may comprise random-access memory (RAM), read-only memory (ROM), electrically erasable programmable read-only memory (EEPROM), optical disc storage, magnetic disk storage, linear magnetic data storage, magnetic storage devices, flash memory, or any other medium which can be used to carry or store desired program code means in the form of computer-executable instructions or data structures. Combinations of the above should also be included within the scope of the non-transitory computer-readable storage media or machine-readable medium.

Snowmobile 101 additionally comprises an occupancy sensor 215 in data communication with master controller 201. Occupancy sensor 215 generates an occupancy signal indicating whether rider 100 has been displaced from snowmobile 101. In the depicted embodiment, occupancy sensor 215 comprises an electrical connection detector in electrical communication with tether port 115 (see FIG. 1), and the occupancy signal indicates that the rider 100 is on snowmobile 101 so long as the riding tether 117 (see FIG. 1) is electrically connected to tether port 115.

Snowmobile 101 additionally comprises a status sensor 223 that generates a status signal indicating the operational state of the prime mover 104. In this embodiment, status sensor 223 generates a status signal based upon the actual operational state of prime mover 104 and also the position of toggle switch 113, but other embodiments may generate a signal based only upon the operational state of prime mover 104 or the position of toggle switch 113 without deviating from the teachings disclosed herein.

In the depicted embodiment, once the status sensor 223 generates a status signal indicating an “active” state of the prime mover 104, this status signal is not changed until a proper “validation cycle” procedure has been completed by a rider. The procedure is referred to as a “validation cycle” because it is a procedure which is understood to validate that the rider has regained control of the snowmobile 101. In the depicted embodiment, a proper validation cycle includes both the disengagement of prime mover 104, and setting the toggle switch 113 to “OFF” position. Once both conditions have been met, the status signal will indicate that the prime mover 104 is in an inactive state. Once the user has reengaged the prime mover 104 by placing the toggle switch 113 back into the “ON” position, the status signal will again indicate the prime mover 104 is in an active state. Other embodiments may not require one of these conditions to be met to sastisfy the validation cycle requirements to permit the status signal to return to indicating an active state.

The velocity signal, occupancy signal, and status signal may be utilized by master controller 201 to implement advanced features of snowmobile 101. By way of example, and not limitation, master controller 101 may send commands to brake controller 205 to apply braking force via brake 105 in response to an adverse condition indicated by one or more of the signals. By way of example, and not limitation, master controller 101 may disengage or reduce the output of prime mover 104 in response to an adverse condition indicated by one or more of the signals.

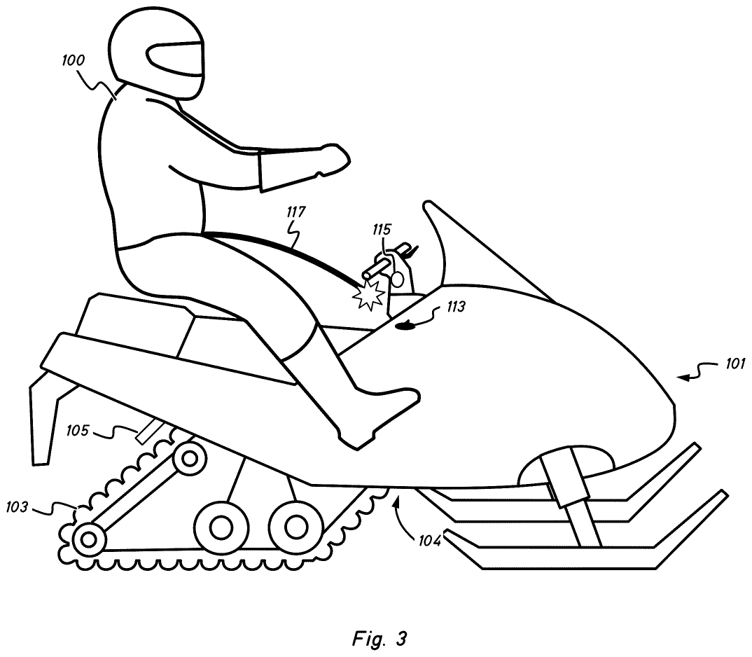

FIG. 3 depicts rider 100 and snowmobile 101 in a situation in which riding tether 117 has become disconnected from tether port 115. In this scenario, master controller 201 (see FIG. 2) receives an updated occupancy signal from occupancy sensor 215 (see FIG. 2) indicating that the riding tether 117 has become disconnected. In response to this, master controller 201 is programmed to interpret this condition as the rider 100 no longer being in control of snowmobile 101, potentially because the rider 100 has been ejected from the snowmobile 101 during operation.

In response to receiving an occupancy signal indicating that rider tether 117 is no longer in electrical connection with tether port 115, master controller 201 is programmed to disengage prime mover 104 and direct brake controller 205 (see FIG. 2) to apply brake 105 to tread 103. Braking force from brake 105 may be increased until velocity senosr 203 generates a velocity signal that indicates that the rotational speed of tread 103 is no greater than a predetermined threshold value. In the depicted embodiment, the threshold value is zero miles per hour, but other embodiments may comprise other threshold values without deviating from the teachings disclosed herein. In the event that the braking force of brake 105 reaches the maximum applicable force, the braking force continues to be applied at maximum braking force until master controller 201 receives an indication that braking may be discontinued.

In the depicted embodiment, the indication that braking may be discontinued is achieved when the occupancy signal indicates that riding tether 117 has been reconnected to tether port 115 and also that status signal indicates that prime mover 104 is an inactive state. Other embodiments may comprise a different condition for discontinuation of braking has been achieved.

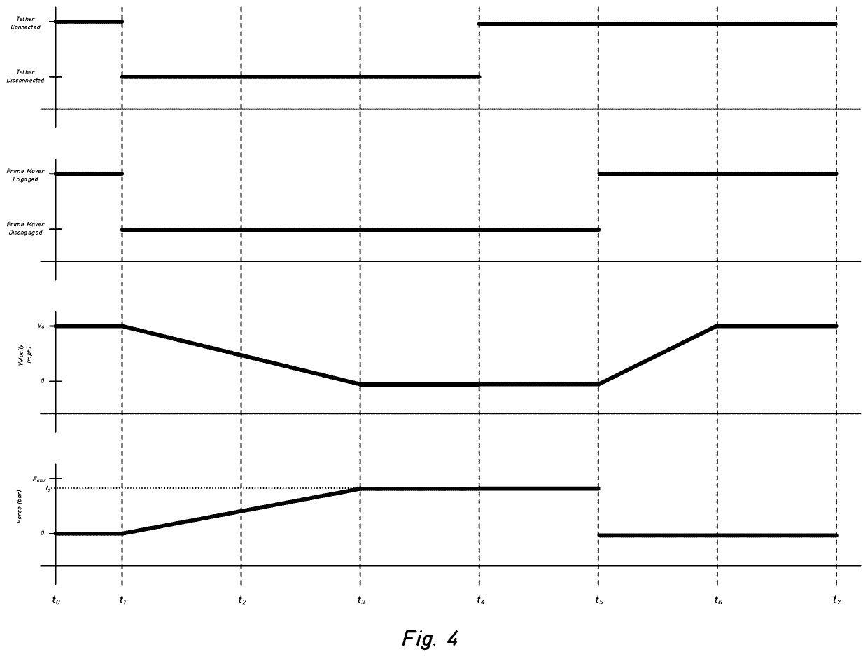

FIG. 4 is a chart showing how a snowmobile (such as snowmobile 101; see FIG. 1-3) will respond to changing conditions. The charts show inputs of an occupancy signal 402, status signal 404, and velocity signal 408 (measured in mph; other units may be used without deviating from the teachings herein), and the output is an applied braking force 408 (measured in bar; other units may be used without deviating from the teachings herein) at various times t. At t₀, the snowmobile is operating in normal operating conditions, with the occupancy signal 402 indicating that a riding tether (such as riding tether 117) is electrically connected to a tether port (such as tether port 115), the prime mover (such as prime mover 104) is in an engaged state, and the tread (such as tread 103) is moving at an initial velocity v₀. For the purposes of this example, the exact value of v₀ is not needed to illustrate the functions described herein. The applied braking force 408 is 0 bar, but a rider (such as rider 100) may manually engage the brakes: applied braking force 408 only illustrates the braking force applied by a braking controller (such as braking controller 205) at the direction of a master controller (such as master controller 201) in response to the input signals.

At t₁, the occupancy signal 402 indicates that the riding tether has become disconnected from the tether port. In response to this, the master controller shuts off the prime mover, causing the status signal 404 to indicate that the prime mover has been disengaged. Since the occupancy signal 402 indicates the riding tether has become disconnected and velocity signal 406 has a non-zero value, the master controller directs the braking controller to being to apply a braking force 408 to slow the turning of the tread. In the depicted embodiment, the brake comprises a variable-force brake component, and the braking force can be increased over time until either the velocity signal indicates that the velocity is at or beneath a predetermined threshold value (in this example, 0 mph), or a maximum braking force Fₘₐₓ has been applied. In some embodiments, the brake may comprise a fixed-force configuration, and the braking force alternates between 0 bar of pressure (when disengaged) and a fixed value of force, such as Fₘₐₓ, when braking is applied without deviating from the teachings disclosed herein. In the depicted embodiment, the variable-force braking comprises a continuous set of braking forces, but other embodiments may utilize a discrete set of limited braking forces (e.g., 5 braking force values in a “graduated” engagement spectrum) without deviating from the teachings disclosed herein.

At t₂, the occupancy signal 402 still indicates that the riding tether is disconnected. Because no power cycling has occurred to indicate to the master controller that the rider has regained control, the prime mover remains disengaged and the status signal 404 continues to indicate this status. The velocity signal 406 still indicates a velocity greater than zero, and thus braking force 408 continues to increase.

At t₃, the occupancy signal 402 still indicates that the riding tether is disconnected, and the prime mover remains inactive, which is reflected by status signal 404. However, at t₃, the velocity signal 406 indicates a rotational velocity of the tread of zero miles per hour. As a result, the master controller instructs the braking controller to maintain the current level of braking force. As a result, braking force 408 stops increasing and holds steady at a value of f₃ bar. For the purposes of this discussion, f₃ may be any non-zero real value not greater than the maximum applicable force, Fₘₐₓ, which in this embodiment is 20 bar, but other embodiments may comprise a different maximum without deviating from the teachings disclosed herein. In the event that the maximum force is applied and the velocity signal 406 indicates a rotational speed greater than zero miles per hour, the maximum force will be continued until the velocity is reduced to zero miles per hour. In this embodiment, the minimum threshold value of the velocity signal 406 is zero miles per hour to disengage the brake, but other embodiments may comprise a different threshold value without deviating from the teachings disclosed herein.

At t₄, the rider is successfully able to reconnect the riding tether to the tether port, and the occupancy signal 402 begins to indicate that the riding tether has been connected. However, the rider has not yet completed a “validation cycle” operation of the prime mover, and thus the prime mover remains disengaged. Status signal 404 reflects this condition of the prime mover. As a result, the braking force 408 holds steady and continues applying a braking force of f₃. Because the braking force remains applied, the tread cannot move, and the velocity signal 406 remains at zero miles per hour.

At t₅, the rider successfully completes a “validation cycle” operation, and the master controller permits re-engagement of prime mover. Thus, status signal 404 indicates that the prime mover has become engaged. Because occupancy signal 402 continues to indicate that the riding tether is connected to the tether port, the braking force is released, and braking force 408 is set to zero bar. Because the brakes have been released, the rider can continue operating the snowmobile normally, and the velocity signal 406 indicates acceleration. By t₆, the operation of the snowmobile has resumed, and the velocity signal 406 indicates that the original velocity v₀ has been safely re-achieved.

In the depicted embodiment, master controller 201 may additionally disengage prime mover 104 in response to the riding tether 117 disconnecting from tether port 115. In such conditions, master controller 201 is programmed to prevent re-engagement of prime mover 104 until the occupancy signal indicates that riding tether 117 has been reconnected to tether port 115, and also status signal indicates that toggle switch 113 has been “powered cycled” by being placed into the OFF position before being returned to the ON position while riding tether 117 is electrically connected to tether port 115. This dual requirement advantageously optimizes safety for the rider by preventing any unwanted operation of prime mover 104 until the rider can safely return to the seat of snowmobile 101 and prepare the snowmobile 101 for further safe operation. In effect, the two-step process acts as a proof to master controller 201 that rider 100 has regained safe access to the controls of snowmobile 100. Other embodiments may comprise other reset conditions without deviating from the teachings disclosed herein.

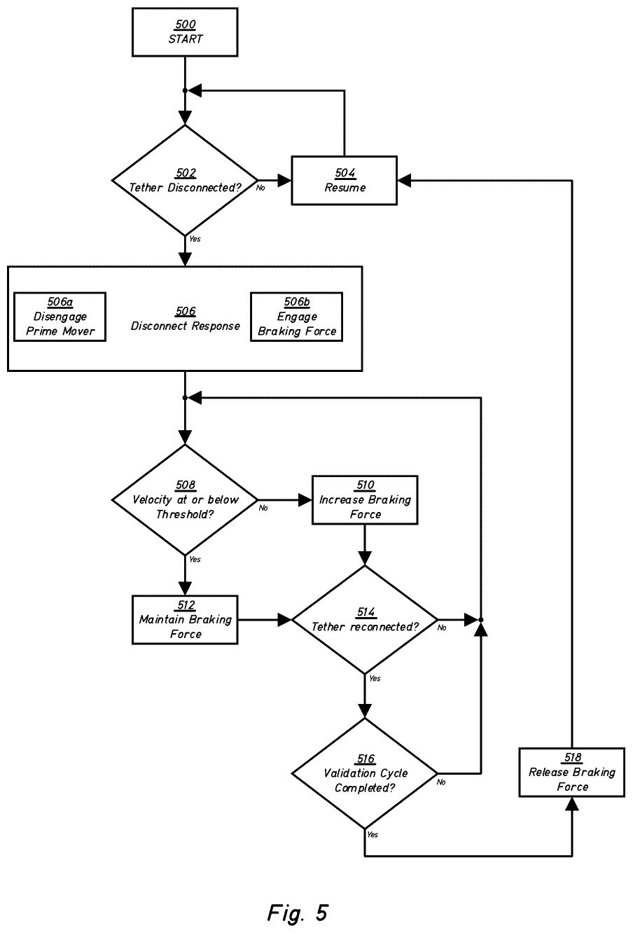

FIG. 5 is a flowchart illustrating a method of autonomous braking for an offroad vehicle having a variable-force brake. In the depicted embodiment, the offroad vehicle may comprise a snowmobile (such as snowmobile 101; see FIG. 1-3), but other embodiments may comprise other configurations without deviating from the teachings disclosed herein. The method begins at step 500, wherein the snowmobile is operating normally. Periodically, the method proceeds to step 502, where it is determined if a riding tether (such as riding tether 117; see FIG. 1-3) has become disconnected from a tether port (such as tether port 115; see FIG. 1-3). If the riding tether remains connected to tether port, the method resumes at step 504 and cycles back to step 502 in the next periodic status update.

However, if the riding tether becomes disconnected, the method proceeds instead to step 506, where a disconnect response commences. Step 506 comprises two substeps. In substep 506a, a prime mover of the snowmobile (such as prime mover 104; see FIG. 1-2) is disengaged, which is prevents uncontrolled motion of the snowmobile as a result of unwanted acceleration in the prime mover. In substep 506b, a braking force is applied via a brake (such as brake 105; see FIG. 1-3). The braking force is controlled by a brake controller (such as brake controller 205; see FIG. 2), and in the depicted embodiment, the braking force may be applied at a variety of intensities. By way of example, and not limitation, the range of braking force applicable via the brake may comprise 0-20 bar, but other embodiments may comprise other ranges without deviating from the teachings disclosed herein. In the depicted embodiment, substeps 506a and 506b are performed at least partially concurrently, but in other embodiments they may be performed consecutively in any order, or completely concurrently without deviating from the teachings disclosed herein.

After the disconnect response is completed at step 506, the method proceeds to step 508, where a velocity signal is measured to determine if the velocity of the snowmobile as measured by its moving components (in this example a tread, such as tread 103; see FIG. 1-3) is at or below a threshold value. In the depicted embodiment, the threshold may be set to zero miles per hour, but in other embodiments a different threshold may be utilized without deviating from the teachings disclosed herein. If the velocity is above the threshold value, the method proceeds to step 510 and the braking force is increased. Otherwise the velocity is at or below the threshold value, and the method proceeds to step 512, where the braking force is maintained until a number of conditions have been satisfied. In the depicted embodiment, the conditions include reconnection of the riding tether to the tether port and power cycling the status of the prime mover, but other embodiments may comprise a different set of conditions without deviating from the teachings disclosed herein. Some such embodiments may comprise only one of the two conditions listed in this example without deviating from the teachings disclosed herein.

Each of steps 510 and 512 proceed to step 514, where it is determined if the riding tether has been reconnected to the tether port. If not, the method returns to step 508 to make another assessment about moving velocity and braking force conditions. If the tether is reconnected, the method proceeds to step 516, where it is determined if a validation cycle of the prime mover has been completed. In this embodiment, a “validation cycle” of the prime mover comprises both a restarting of the disengaged prime mover (which was disengaged at step 506), and also a resetting of a human control of the prime mover status (such as toggle switch 113; see FIG. 1-3), but other embodiments may comprise a different validation cycle procedure without deviating from the teachings disclosed herein. Some such embodiments may comprise only one of the conditions listed in this description without deviating from the teachings disclosed herein. If the validation cycle sequence has not been completely properly, the method returns to step 508 to make another assessment about moving velocity and braking force conditions. In contrast, if the validation cycle has been completed, the method instead proceeds to step 518, where the braking force is released. After step 518, the method returns to step 504 to resume normal operation.

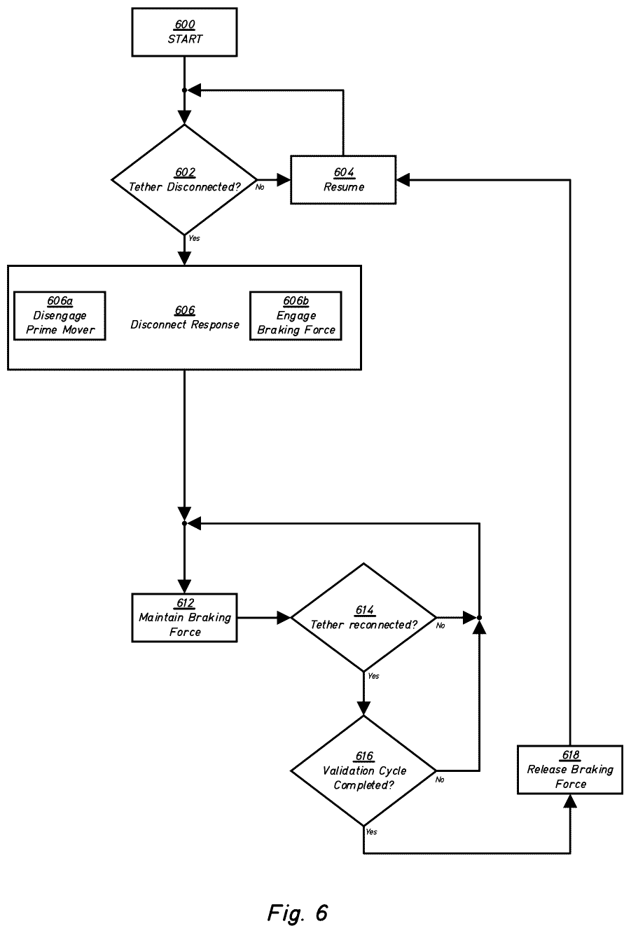

FIG. 6 is a flowchart illustrating a method of autonomous braking for an offroad vehicle having a fixed-force brake. In the depicted embodiment, the offroad vehicle may comprise a snowmobile (such as snowmobile 101; see FIG. 1-3), but other embodiments may comprise other configurations without deviating from the teachings disclosed herein. The method begins at step 600, wherein the snowmobile is operating normally. Periodically, the method proceeds to step 602, where it is determined if a riding tether (such as riding tether 117; see FIG. 1-3) has become disconnected from a tether port (such as tether port 115; see FIG. 1-3). If the riding tether remains connected to tether port, the method resumes at step 604 and cycles back to step 602 in the next periodic status update.

However, if the riding tether becomes disconnected, the method proceeds instead to step 606, where a disconnect response commences. Step 606 comprises two substeps. In substep 606a, a prime mover of the snowmobile (such as prime mover 104; see FIG. 1-2) is disengaged, which is prevents uncontrolled motion of the snowmobile as a result of unwanted acceleration in the prime mover. In substep 606b, a braking force is applied via a brake (such as brake 105; see FIG. 1-3). The braking force is controlled by a brake controller (such as brake controller 205; see FIG. 2), and in the depicted embodiment, the braking force may be applied at single intensity. By way of example, and not limitation, the range of braking force applicable via the brake may comprise 20 bar, but other embodiments may comprise other ranges without deviating from the teachings disclosed herein. In the depicted embodiment, substeps 606a and 606b are performed at least partially concurrently, but in other embodiments they may be performed consecutively in any order, or completely concurrently without deviating from the teachings disclosed herein.

After the disconnect response is completed at step 606, the method proceeds to step 612, where the braking force is maintained until a number of conditions have been satisfied. In the depicted embodiment, the conditions include reconnection of the riding tether to the tether port and power cycling the status of the prime mover, but other embodiments may comprise a different set of conditions without deviating from the teachings disclosed herein. Some such embodiments may comprise only one of the two conditions listed in this example without deviating from the teachings disclosed herein.

Step 612 proceed to step 614, where it is determined if the riding tether has been reconnected to the tether port. If not, the method returns to step 612 to maintain the braking force and prepare to check for reconnection again. If the tether is reconnected, the method proceeds to step 516, where it is determined if a validation cycle of the prime mover has been completed. In this embodiment, a “validation cycle” of the prime mover comprises both a restarting of the disengaged prime mover (which was disengaged at step 606), and also a resetting of a human control of the prime mover status (such as toggle switch 113; see FIG. 1-3), but other embodiments may comprise a different validation cycle procedure without deviating from the teachings disclosed herein. Some such embodiments may comprise only one of the conditions listed in this description without deviating from the teachings disclosed herein. If the validation cycle sequence has not been completely properly, the method returns to step 612 to maintain braking force and prepare to reaffirm that the riding tether remains connected at step 614. In contrast, if the validation cycle has been completed, the method instead proceeds to step 618, where the braking force is released. After step 618, the method returns to step 604 to resume normal operation.

While exemplary embodiments are described above, it is not intended that these embodiments describe all possible forms of the disclosed apparatus and method. Rather, the words used in the specification are words of description rather than limitation, and it is understood that various changes may be made without departing from the spirit and scope of the disclosure as claimed. The features of various implementing embodiments may be combined to form further embodiments of the disclosed concepts.

What is claimed is:

1. A snowmobile control system comprising:
a brake controller that engages a brake applied to a tread of the snowmobile;
an occupancy sensor that generates a occupancy signal indicating whether a riding tether is electrically connected to a tether port of the snowmobile;
a status sensor that generates a status signal indicating the operational state of a prime mover of the snowmobile, the status signal indicating either an active state or an inactive state; and
a master controller in data communication with the occupancy sensor and the status sensor, the master controller activating the brake controller in response to receiving an occupancy signal indicating the riding tether is not electrically connected to the tether port and a status signal indicating an active state of the prime mover,
wherein
the occupancy sensor is in electrical communication with the tether port.

2. The snowmobile control system of claim 1, further comprising a tread sensor in data communication with the master controller and generating a velocity signal indicating a rotational speed of the tread, wherein the brake controller disengages the brake in response to the velocity signal indicates a speed no greater than a predetermined threshold.

3. The snowmobile control system of claim 1, further comprising a tread sensor in data communication with the master controller and generating a velocity signal indicating the rotational speed of the tread wherein the brake utilizes a variable-force brake actuator, wherein the brake controller increases the force of the brake until the velocity signal indicates a speed no greater than a predetermined threshold.

4. The snowmobile control system of claim 1, further comprising a tread sensor in data communication with the master controller and generating a velocity signal indicating the rotational speed of the tread wherein the brake utilizes a fixed-force brake actuator, wherein the brake controller applies a fixed force of the brake until the velocity signal indicates a speed no greater than a predetermined threshold.

5. The snowmobile control system of claim 1, wherein the brake controller disengages the brake in response to the status signal indicating the prime mover has transitioned from an active state to an inactive state.

6. The snowmobile control system of claim 1, wherein the master controller is in further data communication with the prime mover and disengages the prime mover in response to the occupancy signal indicating that there is not a riding tether electrically connected to the tether port.

7. The snowmobile control system of claim 1, wherein the brake controller disengages the brake in response to the occupancy signal indicating that a riding tether is in electrical connection with the tether port and the status signal indicates an inactive state of the prime mover.

8. A method of snowmobile control during operation of the snowmobile while a rider tether is in electrical connection to a tether port of the snowmobile comprising:
detecting that the riding tether is electrically disconnected with the tether port via an occupancy sensor;
activating a brake controller to engage a brake of the snowmobile against a tread of the snowmobile in response to the removal of the riding tether; and
maintaining the brake engagement until a disengagement condition is detected.

9. The method of claim 8, wherein the disengagement condition comprises a rotational speed of the tread as measured by a tread sensor indicating a speed of zero miles per hour.

10. The method of claim 8, wherein the disengagement condition comprises the occupancy sensor indicating the riding tether is electrically connected to the tether port.

11. The method of claim 8, wherein the disengagement condition comprises a status signal indicating the operational state of a prime mover of the snowmobile as generated by a status sensor indicates that the prime mover is inactive.

12. The method of claim 8, wherein the disengagement condition comprises either a rotational speed of the tread as measured by a tread sensor indicating a speed of zero miles per hour or the occupancy sensor indicating the riding tether is electrically connected to the tether port and a status signal indicating the operational state of a prime mover of the snowmobile as generated by a status sensor indicates that the prime mover is inactive.

13. The method of claim 8, wherein the brake comprises a variable-force brake actuator and the brake controller increases the braking force applied by the brake until a rotational speed of the tread as indicated by a velocity sensor achieves a speed of zero miles per hour.

14. The method of claim 8, wherein the brake comprises a fixed-force brake actuator and the brake controller applies the fixed braking force applied by the brake until a rotational speed of the tread as indicated by a velocity sensor achieves a speed of zero miles per hour.

15. A non-transitory computer-readable medium having instructions thereon that cause a processor to, in response to the instructions, perform a method of snowmobile control during operation of the snowmobile while a rider tether is in electrical connection to a tether port of the snowmobile comprising:
detecting that the riding tether is electrically disconnected with the tether port via an occupancy sensor;
activating a brake controller to engage a brake of the snowmobile against a tread of the snowmobile in response to the removal of the riding tether; and
maintaining the brake engagement until a disengagement condition is detected.

16. The non-transitory computer-readable medium of claim 15, wherein the disengagement condition comprises a rotational speed of the tread as measured by a tread sensor indicating a speed of zero miles per hour.

17. The non-transitory computer-readable medium of claim 15, wherein the disengagement condition comprises the occupancy sensor indicating the riding tether is electrically connected to the tether port.

18. The non-transitory computer-readable medium of claim 15, wherein the disengagement condition comprises a status signal indicating the operational state of a prime mover of the snowmobile as generated by a status sensor indicates that the prime mover is inactive.

19. The non-transitory computer-readable medium of claim 15, wherein the disengagement condition comprises either a rotational speed of the tread as measured by a tread sensor indicating a speed of zero miles per hour or the occupancy sensor indicating the riding tether is electrically connected to the tether port and a status signal indicating the operational state of a prime mover of the snowmobile as generated by a status sensor indicates that the prime mover is inactive.

20. The non-transitory computer-readable medium of claim 15, wherein the brake comprises a variable-force brake actuator and the brake controller increases the braking force applied by the brake until a rotational speed of the tread as indicated by a velocity sensor achieves a speed of zero miles per hour.
